(19) United States
(12) Patent Application Publication
(10) Pub. No.: US 2022/0134783 A1
(43) Pub. Date: May 5, 2022

(54) METHOD OF HANDLING A SHEET DEFECT ERROR IN A DUPLEX PRINT PROCESS

(71) Applicant: Canon Production Printing Holding B.V., Venlo (NL)

(72) Inventors: Harm R. HAAN, Venlo (NL); Daniel J.W. LINDENAAR, Venlo (NL); Henricus J.A. VAN DE SANDE, Venlo (NL)

(73) Assignee: Canon Production Printing Holding B.V., Venlo (NL)

(21) Appl. No.: 17/506,988

(22) Filed: Oct. 21, 2021

(30) Foreign Application Priority Data
Oct. 29, 2020 (EP) 20204779.1

(51) Int. Cl. B41J 13/00; B41J 3/60; B41J 11/00; B41J 2/17; B41J 29/393

(52) U.S. Cl. CPC B41J 13/009; B41J 3/60; B41J 2203/011; B41J 2/1721; B41J 29/393; B41J 11/009

(57) ABSTRACT

A method of handling a sheet defect error in a duplex print process, wherein media sheets are successively supplied along a feed path and are moved past a print engine where a first image is printed on a first side of each sheet in a first print pass, the sheets are then returned, via a duplex loop that contains a sheet flipping mechanism, to the feed path upstream of the print engine so that a second image can be printed on a second side of each sheet in a second print pass, the finished sheets being then discharged in a predetermined page sequence, and wherein, when a sheet defect is found a first print pass of a sheet, the defective sheet is diverted into an eject path downstream of the print engine, and a print pass for an immediate successor of the defective sheet is skipped. The subsequent semi-finished sheets are recirculated in the duplex loop while the supply of fresh sheets into the feed path is interrupted, and duplex printing is resumed during or after recirculating the subsequent semi-finished sheets.

### CROSS REFERENCE TO RELATED APPLICATIONS

This application claims priority under 35 U.S.C. § 119(a) to Application No. 20204779.1, filed in Europe on Oct. 29, 2020, the entire contents of which is hereby incorporated by reference into the present application.

### BACKGROUND OF THE INVENTION

### Field of the Invention

The invention relates to a method of handling a sheet defect error in a duplex print process wherein media sheets are successively supplied along a feed path and are moved past a print engine where a first image is printed on a first side of each sheet in a first print pass, the sheets are then returned, via a duplex loop that contains a sheet flipping mechanism, to the feed path upstream of the print engine so that a second image can be printed on a second side of each sheet in a second print pass, the finished sheets being then discharged in a predetermined page sequence, and wherein, when a sheet defect is found in the first print pass of a sheet, the defective sheet is diverted into an eject path downstream of the print engine, and a print pass for an immediate successor of the defective sheet is skipped.

More particularly, the invention relates to a method of handling sheet defect errors in an ink jet printer. The print engine of an ink jet printer comprises an array of ink jet print heads that are arranged above a print surface that forms part of the feed path for the media sheets, so that ink droplets may be ejected onto a sheet passing through. In order to achieve a high print quality, the print heads should form only a narrow gap with the top surface of the media sheets on the print surface. Then, if a sheet has a defect that results in parts of the sheet projecting upwards from the print surface, e.g. due to waviness of the sheet or a fissure in the sheet, there is a risk that the print heads collide with the projecting part of the sheet or that at least the projecting part of the sheet comes in contact with the print head, which may cause damage not only to the sheet but also to the print heads. In particular, the fine nozzles of the print heads may become clogged with dust or partly-dried ink scratched from the surface of the sheet. Furthermore, this may result in the print engine or other parts of the printer becoming contaminated with ink or primer.

### BACKGROUND OF THE INVENTION

US 2018345693 A1 discloses an ink jet printer wherein a detector and a sheet ejector are provided for detecting and ejecting defective sheets upstream of the print engine.

In duplex printing, when a defective sheet has been ejected that carried already a first image on its first side, it is generally necessary to re-arrange the print order so as to preserve the page sequence of the finished sheets that are stacked on an output tray of the printer. Frequently, this requires that at least some of the semi-finished sheets in the duplex loop must be discarded even when these sheets have no defects.

In other ink jet printers, which have no sheet surface height scanner for detecting defective sheets, sheet defect errors such as a collision of parts of a sheet with the print heads may occur from time to time. In these printers, the defective sheets are ejected only downstream of the print engine when an error has actually occurred. However, it may then be necessary to start a print head recovery routine for restoring the proper function of the print heads, for example by wiping a nozzle face of the print head or by “spitting” liquid ink from the nozzles of the print head or printing recovery patterns in order to remove any contaminants from the nozzle orifices. In such printers, a waste of semi-finished sheets may occur even when the sheet defect error occurs in the first print pass of a sheet. The reason is that the recovery time that is needed for restoring the proper function of the print heads may be longer than the time interval between two successive media sheets, so that the immediate successor of the defective sheet, which will in general be a semi-finished sheet returning from the duplex loop, reaches the print engine already at a time before the print heads are again ready for printing. Consequently, this sheet and all subsequent semi-finished sheets returning from the duplex loop must be discarded in order to preserve the page order of the sheets. Thus, if the duplex loop contains a large number of sheets, a considerable amount of waste will be produced. In some ink jet printers, the capacity of the duplex loop may be as large as 36 sheets, for example.

It is therefore an object of the invention to provide a method for handling sheet defect errors with reduced production of waste.

### SUMMARY OF THE INVENTION

In order to achieve this object, the method according to the invention is characterized in that the subsequent semi-finished sheets are recirculated in the duplex loop while the supply of fresh sheets into the feed path is interrupted, and duplex printing is resumed during or after recirculating the subsequent semi-finished sheets.

Thus, when a sheet defect error occurs in the first print pass of a sheet, the semi-finished sheet that is the immediate successor of the defective sheet and that cannot yet be finished by printing the second image, is not discarded but is recirculated in the duplex loop until it reaches the print engine again in the right orientation for receiving the second image on its second side. A number of subsequent semi-finished sheets will also be kept circulating in the duplex loop until printing is resumed with the sheet that was the immediate successor. This will assure that the page order of the printed sheets is not disrupted. Of course, as long as the sheets are recirculated in the duplex loop, the loop will not be cleared of finished sheets, and, consequently, the supply of fresh sheets into the duplex loop must be interrupted at least for a certain time in order to avoid an overflow of the duplex loop. A first fresh sheet may be supplied again at an appropriate timing for replacing the defective sheet that has been discarded.

The principle of the invention is also applicable in a case where a sheet defect error does not occur in the first print pass of a sheet but in the second print pass. The only difference is that in this case, since the immediate successor of the defective sheet will be a fresh sheet that does not yet carry any image, there is a choice whether to discard this sheet or to keep it. For reasons that will be explained below, there may be good reasons to discard the immediate successor and optionally also one or more semi-finished sheets following immediately thereafter. However, the bulk of the semi-finished sheets will be kept circulating in the duplex loop until they reach the print engine again in the correct orientation for being finished, so that duplex printing can be resumed. The first fresh sheets that will be printed on when duplex printing is resumed will in this case be the sheets that replace the sheets that have been discarded.

Thus, in another aspect, the invention also provides a method of handling a sheet defect error in a duplex print process wherein media sheets are successively supplied along a feed path and are moved past a print engine where a first image is printed on a first side of each sheet in a first print pass, the sheets are then returned, via a duplex loop that contains a sheet flipping mechanism, to the feed path upstream of the print engine so that a second image can be printed on a second side of each sheet in a second print pass, the finished sheets being then discharged in a predetermined page sequence, and wherein, when a sheet defect is found in the second print pass of a sheet, the defective sheet is diverted into an eject path downstream of the print engine, and a print pass for an immediate successor of the defective sheet is skipped, characterized in that a number of the subsequent semi-finished sheets are recirculated in the duplex loop while the supply of fresh sheets into the feed path is interrupted, and duplex printing is resumed with the recirculated sheets.

It is noted that the invention may also be advantageously applied in a duplex print process that is provided with a sheet surface height scanner, as it reduces waste in the case sheets returning from the duplex loop have deformed too much since the first print pass. For example, the sheet was originally (prior to the first print pass) not found defective, but due to for example the sheet becoming moist during the first print pass, or due to drying in the duplex loop, or due to transportation in the paper path, the sheet deforms and has become defective. Furthermore, an eject path for the defective sheet may be located upstream of the print engine to remove the sheet prior to it passing the print engine, as well as downstream of the print engine to remove the sheet after it has passed the print engine.

More specific optional features of the invention are indicated in the dependent claims.

Depending upon the design of the feed path, it may not be possible to stop the supply of fresh sheets immediately when a sheet defect error occurs. For example, the feed path will frequently comprise a portion that is located upstream of a switch where the duplex loop joins the feed path. If fresh sheets have been supplied already into that portion of the feed path, it may not be possible or not be desirable to stop these sheets. Instead, these sheets can be moved on past the print engine and may then be diverted into the eject path in order to prevent an overflow of the duplex loop.

If the recovery procedure for the print engine comprises for example a step of spitting ink out of the nozzles, then the fresh sheets that will be discarded may be utilized to catch the ink that is spit from the nozzles, so that the print surface is not contaminated with ink. Likewise, the fresh sheets to be discarded may be utilized to print recovery patterns on.

Similarly, if the sheet defect error occurs in the second print pass of a sheet, then the immediate successor of that sheet, and optionally one or more sheets following thereafter, may be utilized as spitting ink collectors and may than be discarded rather than being recirculated in the duplex loop.

In case of a printer in which the sheet flipping mechanism in the duplex loop cannot be bypassed, the orientation of the semi-finished sheets will be inverted each time they go through the sheet flipping mechanism. Consequently, the recirculated sheets will have to travel at least two rounds in the duplex loop in order for them to be again in the correct orientation for receiving the second image on the second side.

On the other hand, if the printer is of a type wherein the sheet flipping mechanism can be disabled or bypassed, then the recirculated sheets can be kept in their original orientation during the first round, so that they will reach the print engine in the correct orientation already after the first round, and, consequently, productivity will be enhanced.

### BRIEF DESCRIPTION OF THE DRAWINGS

Embodiment examples will now be described in conjunction with the drawings, wherein:

FIGS. 1 to 3 are diagrams of a duplex loop, illustrating a regular duplex print process:

FIGS. 4 to 8 are diagrams illustrating a method for handling a sheet defect error that occurs in a first print pass of a sheet;

FIGS. 9 to 12 are diagrams illustrating a method for handling a sheet defect error occurring in a second print pass; and

FIGS. 13 and 14 are diagrams illustrating a method according to the invention that is adapted to a different type of printer.

### DETAILED DESCRIPTION OF THE PREFERRED EMBODIMENTS

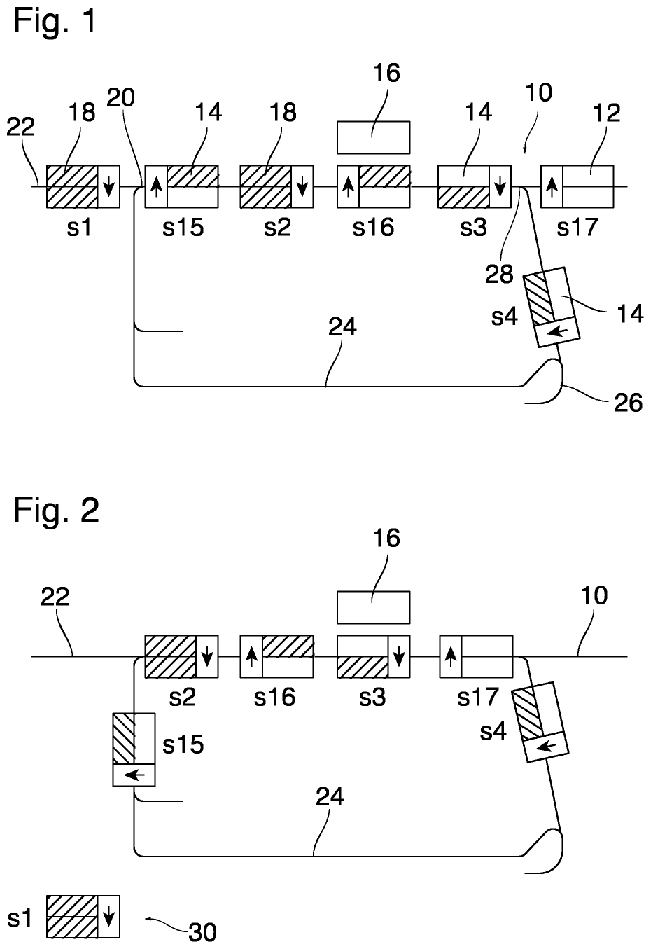

FIG. 1 is a simplified diagram of an ink jet printer having a feed path 10 arranged for feeding a succession of fresh sheets 12 and semi-finished sheets 14 towards and past an ink jet print engine 16 and for conveying the semi-finished sheets 14 and finished sheets 18 towards a switch 20 where the feed path branches into a discharge path 22 and a duplex loop 24. The movements of the sheets and the operation of the print engine are controlled by a controller (not shown). The finished sheets 18 are directed into the discharge path 22 whereas the semi-finished sheets 14 are directed into the duplex loop 24. The duplex loop includes a sheet flipping mechanism 26 where the orientation of the semi-finished sheets 14 is reversed before these sheets are returned into the feed path 10 via a switch 28.

The fresh sheets 12 are separated from a supply stack (not shown) and are conveyed into the portion of the feed path 10 that is located between the switches 20 and 28. In this portion of the feed path, the semi-finished sheets 14 are interleaved with the fresh sheets 12 upstream of the print engine 16 and with the finished sheets 18 downstream of the print engine. In the present example, in every second print cycle of the print engine 16, a fresh sheet 12 is turned into a semi-finished sheet 14, and in the intervening print cycles a semi-finished sheet 14 will respectively be turned into a finished sheet 18, so that the number of semi-finished sheets in the duplex loop 24 can remain constant.

The sheets are numbered by sheet numbers s1-s16 in the order in which they are to be discharged via the discharge path 22. In the example considered here, the duplex loop 24 can accommodate up to fourteen semi-finished sheets 14 (s3-s16) only some of which have been shown in FIG. 1.

In the example described here, it shall be assumed that the transport speed of the sheets in the duplex loop 24, more precisely, in the part from the switch 20 back to the switch 28, is only one half of the transport speed of the sheets in the feed path 10. Consequently, the interval between successive sheets in the duplex loop is only one half of the sheet-to-sheet interval in the feed path 10, which means that the gaps left by the finished sheets 18 that have been discharged are closed when the sheets enter into the duplex loop, and new gaps for accommodating the fresh sheets 12 are opened when the sheets return into the feed path 10. A reason for this design may be to provide more time for the ink on the semi-finished sheets to cure and for the sheets to cool down before they are fed to the print engine 16 again.

In the situation shown in FIG. 1, the print engine 16 is busy with performing a first print pass for sheet s16 which has been a fresh sheet and now receives a first image on a first side (top side), which turns this sheet into a semi-finished sheet.

FIG. 2 illustrates the situation one print cycle later, i.e. when the sheets have moved by one position in the feed path 10. Thus, the sheet s16 is now a semi-finished sheet that has just left the print engine, and its immediate successor, sheet s3, is receiving a second image on its second side in a second print pass. It is noted that the second side of the sheet s3 is the top side because the sheet has been flipped in the sheet flipping mechanism 26.

As is further shown in FIG. 2, the finished sheet s1 has left the discharge path 22 and has been deposited on a stack 30, whereas the subsequent sheet s15 has entered into the duplex loop 24.

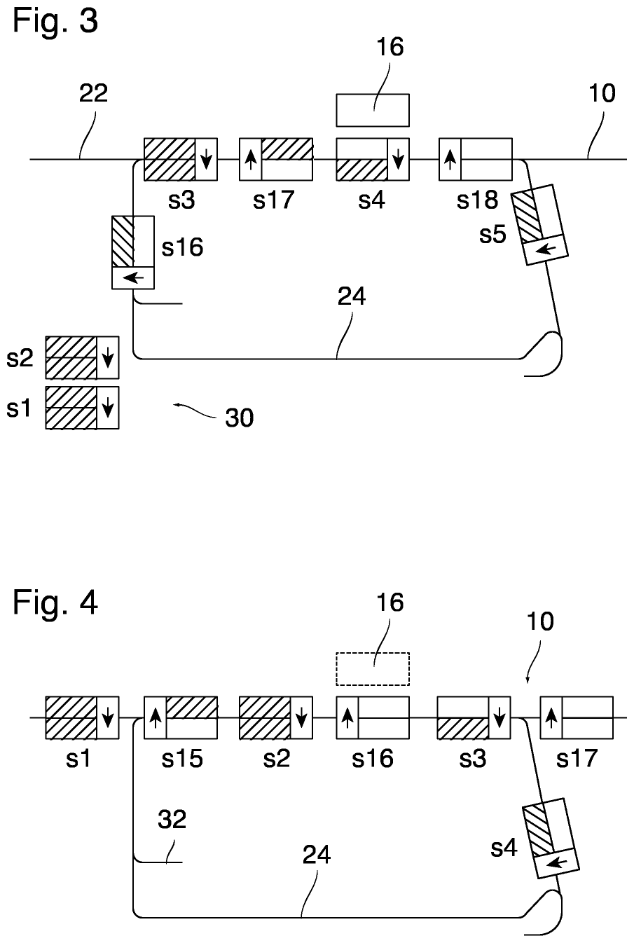

FIG. 3 illustrates the situation another two print cycles later. Compared to FIG. 2, the sheets in the feed path 10 have moved by two positions (whereas the sheets in the duplex loop 24 have shifted only one position), and the print engine 16 is now performing the second print pass for sheet s4, turning this sheet into a finished sheet. The sheet s2 has left the discharge path 22 and has been deposited on the stack 30. Note that the orientation of the sheets s1 and s2 in the stack 30 is face-down, so that the images printed on the bottom and top sides of these sheets observe a regular page order with page numbers increasing from bottom to top, odd-numbered pages being on the bottom sides of the sheets and even-numbered pages being on the top sides.

FIG. 4 illustrates again the same situation as FIG. 1, but now for the case that the sheet s16 that is in its first print pass causes a sheet defect error, e.g. by colliding with some of the print heads of the print engine 16. The error is detected automatically and the print pass is aborted, which is symbolized in FIG. 4 by showing the print engine 16 only in phantom lines. Consequently, the top side of sheet s16 does not receive a complete image and will have to be discarded. For that purpose, an eject path 32 branches off from the duplex loop 24.

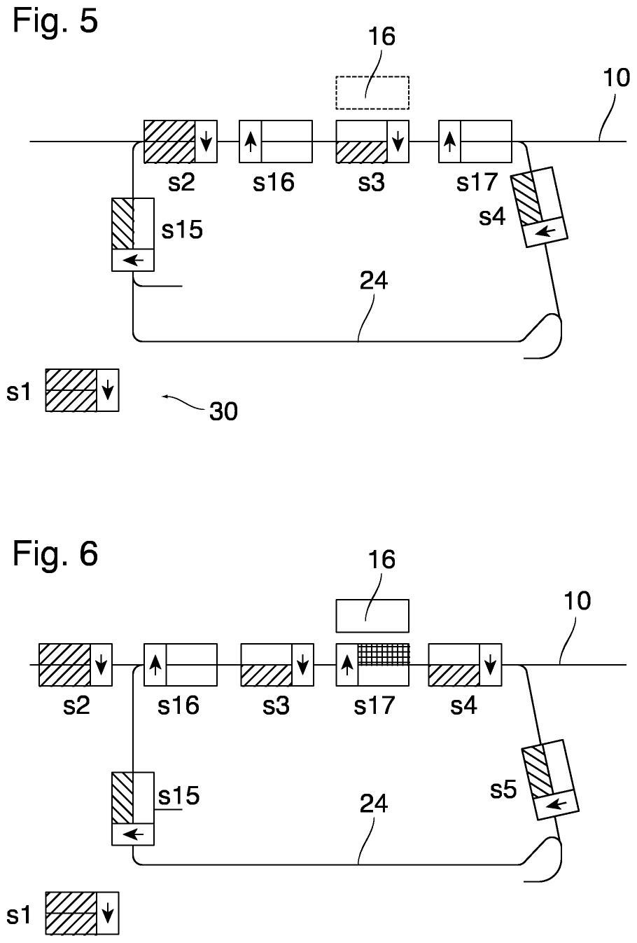

If it could be taken for granted that the sheet defect error has not compromised the print quality achievable with the print engine 16 in subsequent print passes, then the print process could simply proceed with finishing sheet s3 and then printing the contents that were intended for the top side of sheet s16 onto the next fresh sheet s17. However, if it must be feared that the print quality has been compromised, then a recovery procedure for the print engine 16 is necessary. For example, the recovery procedure may comprise flushing the nozzles of the print heads by “spitting” ink onto the sheet 16 which will be discarded anyway or by printing recovery patterns on it. It is possible, however, that the time required for the recovery process is longer than the time gap between successive sheets in the feed path 10. Then, as has been illustrated in FIG. 5, the print engine 16 is not yet ready for printing at the time when sheet s3 reaches the position underneath the print engine. Consequently, the second side on sheet s3 cannot be printed property, neither.

A conventional error handling method would now require that sheet s3 is also discarded. Since this would mean that the corresponding page numbers (pages 5 and 6) would be missing in the stack 30, it would also be necessary to discard all the sheets s4-s15 that are presently in the duplex loop 24. i.e. to flush the entire duplex loop, and then to resume printing with printing the first image (page 5) on the first side of a fresh sheet and then, when the sheet has been flipped in the duplex loop, to print the second image (page 6) on the second side, so that the sheet, when discharged, could substitute the discarded sheet s3. This would mean that all the semi-finished sheets (s3 to s15 in this example) would be wasted.

In order to reduce this waste, the invention proposes a different method that will now be explained by reference to FIGS. 6 to 8.

FIG. 6 illustrates the situation one print cycle later than in FIG. 5. The sheets in the feed path 10 have shifted by one position and the top side of sheet s3 has been left blank. In this example, it is assumed that the separation of fresh sheets from the supply stack has been stopped immediately when the sheet defect error was detected (FIG. 4). However, the fresh sheet s17 had been separated already and could not be prevented from approaching the print engine. In FIG. 6, this sheet s17 is used as a collector for collecting ink that is spat out from the nozzles of the print heads as part of the recovery process. Thus, the time available for spitting is not limited to the time in which the defective sheet s16 was under the print engine (FIG. 4) but spitting can be resumed when the sheet s17 is under the print engine. However, spitting is interrupted while the sheet s3 is under the print engine in order to prevent the top side of that sheet from being stained.

In order to prevent the production of excessive waste, only the defective sheet s16 and sheet s17 will be discarded whereas the semi-finished sheets s3-s15 are kept in the duplex loop 24. Thus, in the print cycles subsequent to the one shown in FIG. 6, the sheet s16 will be deflected into the duplex loop 24 and then into the reject path 32, the print engine 16 (having meanwhile finished the recovery process) is kept silent, so that the top sides of the semi-finished sheets s4-s15 remain blank as these sheets move past the print engine.

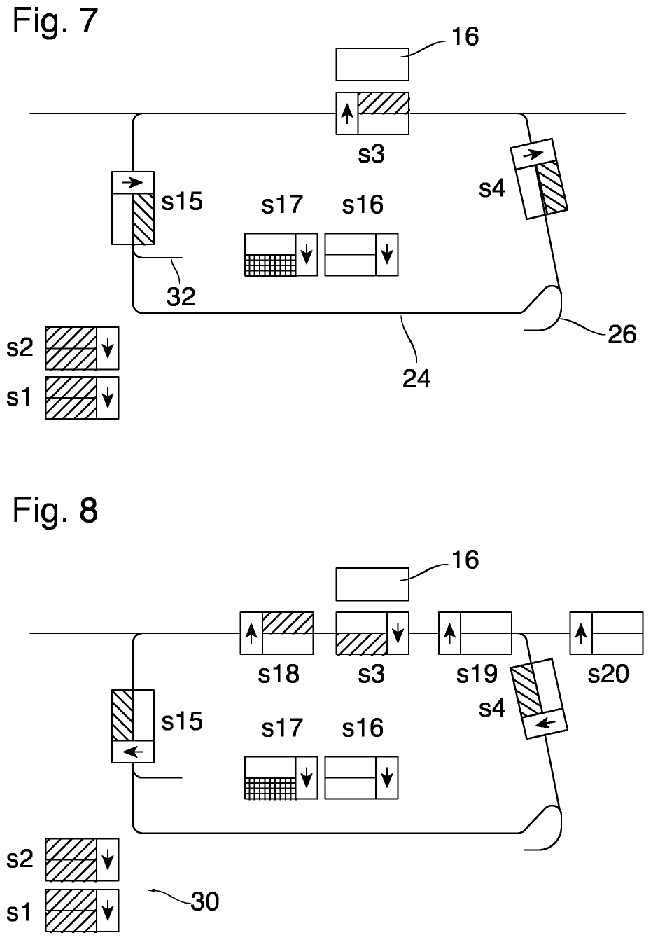

FIG. 7 shows the situation twenty-seven print cycles later than FIG. 6, i.e. twenty-eight print cycles later than FIG. 5. Since the duplex loop 24 can accommodate fourteen semi-finished sheets (including those in the feed path 10) and it takes two print cycles to shift the sheets in the duplex loop 24 by one position, the semi-finished sheets s3-s15 have completed exactly one round along the duplex loop 24 in the situation shown in FIG. 7. Consequently, these sheets have reached the same positions as in FIG. 5, but now with the orientations being reversed because the sheets have been flipped in the sheet flipping mechanism 26.

As is further shown in FIG. 7, the sheets s16 and s17 have been discarded and ejected via the eject path 32. It is noted that the sheet s17 which had served as spitting collector in the recovery process had to be discarded anyway, because the capacity of the duplex loop 24 is not sufficient for accommodating this sheet. In normal operation of the printer, the number of semi-finished sheets in the duplex loop 24 is constant, but when the semi-finished sheets are not finished and remain in the duplex loop, the loop is not being emptied anymore and cannot accommodate new sheets such as the sheet s17.

Depending upon the design of the printer, it is possible that not only the sheet S17 is already in the feed path when the sheet defect error is detected, but there are two or more sheets already in the feed path. Then, these additional sheets would also have to be ejected and, optionally, could be used for spitting when passing underneath the print engine.

As can further be seen in FIG. 7, the sheet s3, although it is in the right position for being printed on, has not the correct orientation for receiving the second image on the second side. The same applies to sheet s4. Sheet s15 would have the correct orientation in FIG. 7 but still has to pass the sheet flipping mechanism and therefore will be flipped before it reaches the print engine again.

Thus, in this embodiment, the sheets that have been recirculated in the duplex loop 24 will have to make another round in the loop so that their orientations are flipped once more, as has been shown in FIG. 8.

FIG. 8 shows the situation another twenty-eight print cycles later than FIG. 7, so that the sheets s3, etc. are again in the same positions, but now with the correct orientations. Thus, sheet s3 can now be finished and placed on the stack 30. However, since sheet s16 had been discarded, a substitute for that discarded sheet must be provided. Since sheet s16 has been the immediate predecessor of sheet s3, a fresh sheet s18 has been separated from the supply stack and moved past the print engine 16 just in time to be right ahead of sheet s3. The image that originally was intended for the first side of sheet s16 has now been printed on the first side of sheet s18. Thus, the duplex print process is now resumed with the sheets s18 and s3, followed by fresh sheets s19, s20 separated from the supply stack and interleaved with the semi-finished sheets s4, . . . , s15, s18 (second pass), and so on.

In this example, instead of discarding all the sheets s16 and s3-s15, only two sheets (s16 and s17) have been discarded, so that the amount of waste has been reduced significantly.

Note that it is not strictly necessary that printing of the second side of the semi-finished sheets s4, . . . , s15 resumes after the substitute sheet s18 has been printed. As soon as the recovery procedure for the print engine 16 has completed printing of the second side may resume with the first semi-finished sheet passing the print engine 16 provided the sheets are oriented correctly and the sheets are kept in the recirculation until earlier semi-finished sheets are also printed on their second side so that all of them can be discharged in their predetermined page sequence. From a productivity point of view, it makes no difference whether the second side of the semi-finished sheets is printed after the substitute sheet s18 has been printed or earlier because the delay caused by the recirculation is determined by the moment that the first semi-finished sheet s4 that is to be discharged has been printed and is ready for discharge.

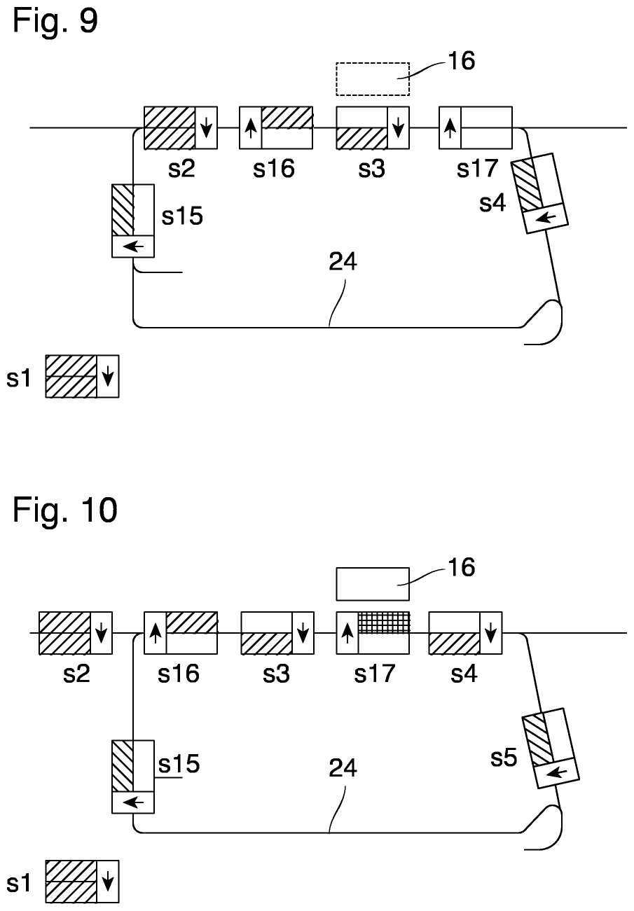

In FIG. 9 the sheets are in the same position as in FIG. 2, but this time it is assumed that a sheet defect error is caused by the semi-finished sheet s3 in its second pass. Such events are relative rare but may nevertheless occur if a damage is inflicted on a sheet while it passes through the duplex loop.

The immediate successor of sheet s3, sheet s17 is a fresh sheet which does not yet bear any image. This sheet could be kept the duplex loop in the later stages of the error handling routine, but could also be replaced by another fresh sheet at any appropriate time. In the example shown here, the sheet s17 is used as a spitting collector in the recovery process for the print heads, as has been illustrated in FIG. 10.

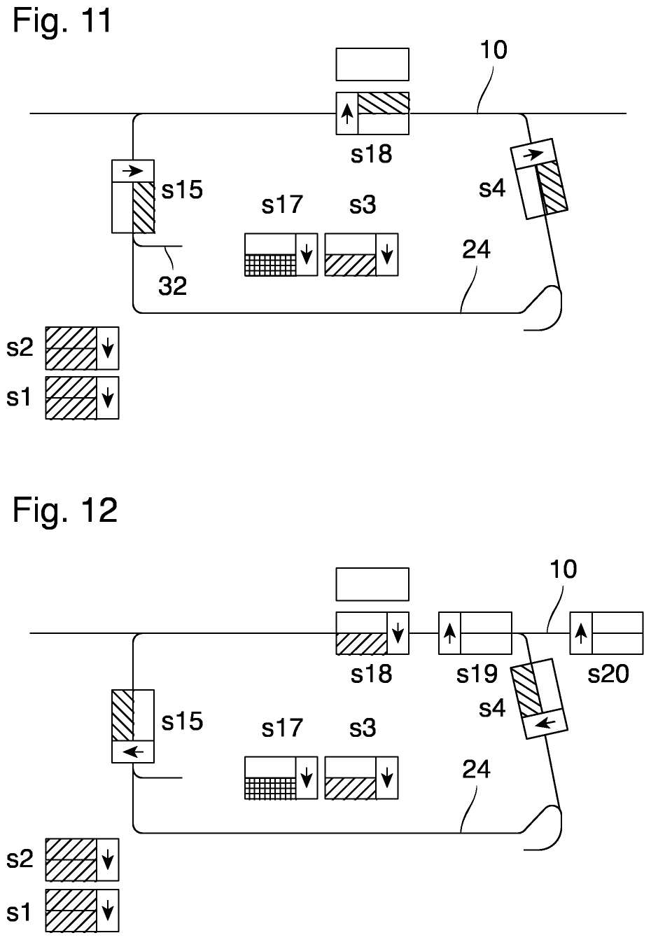

FIG. 11 illustrates the situation twenty-eight print cycles later than in FIG. 9. The sheets s3 and s17 have been ejected via the reject path 32, and all other sheets are in the same positions as in FIG. 9, though with the wrong orientation. Further, a fresh sheet s18 has timely been supplied into the feed path 10 to serve as a substitute for the discarded sheet s3. In FIG. 11, the sheet s18 is just receiving a first pass image.

FIG. 12 illustrates the situation another twenty-eight print cycles later. All sheets, including sheet s18, are again in the same positions as in FIG. 11, but now in the correct orientation for receiving a second pass image. At this point, duplex printing is resumed with sheet s18 being the first sheet that is printed on, and new fresh sheets s19 and s20 are timely supplied into the feed path 10 so as to be interleaved with the semi-finished sheets s4-s15 returning from the duplex loop. It will be understood that the image contents printed on the two sides of sheet s18 are the contents that were originally intended for sheet s3, and sheet s19 will receive the contents intended for sheet s17.

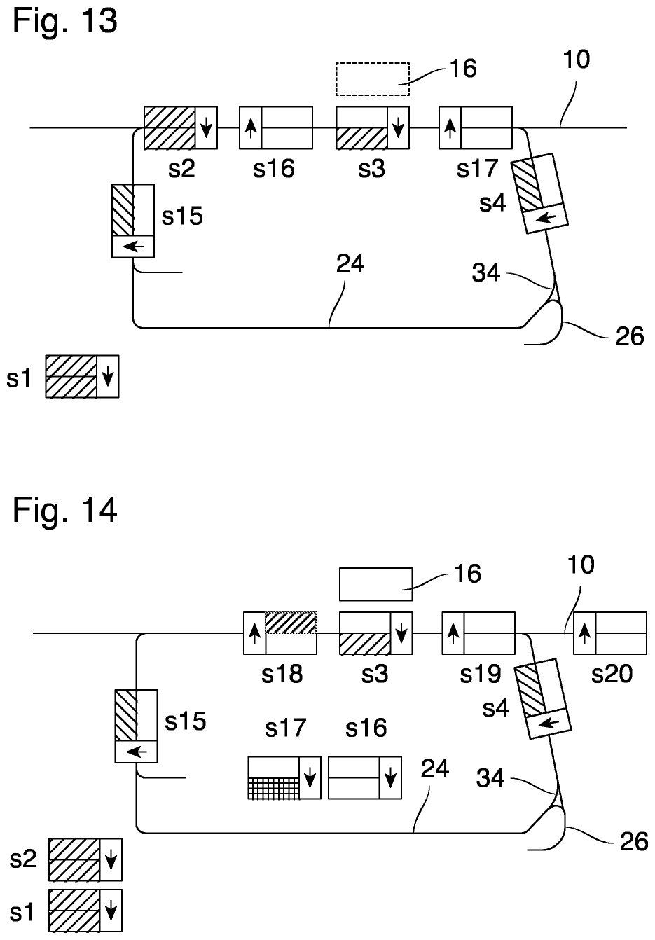

FIGS. 13 and 14 illustrate a modified version of the error handling methods that have been described above. This version is adapted to a specific type of printer which has the outstanding feature that a bypass 34 in the duplex loop 24 offers the option for a sheet to bypass the sheet flipping mechanism 26, so that the orientation of the sheet will not be changed.

The situation illustrated in FIG. 13 is the same as in FIG. 5. The sheet s16 has caused a (first pass) sheet defect error and has not been printed on, so that this sheet will have to be ejected. The immediate successor, sheet s3 cannot be printed on because the recovery process for the print heads is not completed. This sheet will nevertheless be kept in the duplex loop. However, while sheets s3-s15 are recirculated in the duplex loop 24, switches for the bypass 34 are controlled such that these sheets bypass the sheet flipping mechanism 26, so that their orientation will not be changed. Twenty-eight print cycles later, all semi-finished sheets are again in the same position and also have the same orientation as in FIG. 13, so that duplex printing can be resumed with finishing these sheets already after only one round through the duplex loop. Meanwhile, as is further shown in FIG. 14, new fresh sheets s18, s19 and s20 have been separated just in time to be inserted into the stream of semi-finished sheets, sheet s18 being a substitute for the defective sheet s16, and sheet s19 being a substitute for the discarded sheet s17 which had again been used as a spitting ink collector.

It will be understood that the modification shown in FIGS. 13 and 14 can analogously be applied in a situation where a second pass error occurs, as in FIG. 9.

Although the examples provided in here often relate to ink jet print engines, these examples are merely chosen because the invention will have more impact in ink jet based printing processes. However, the invention may also be applied to other printing technologies in cut sheet printing, for example toner or liquid toner based technologies.

1. A method of handling a sheet defect error in a duplex print process, comprising the steps of:
successively supplying media sheets along a feed path and past a print engine where a first image is printed on a first side of each sheet in a first print pass;
returning the sheets, via a duplex loop that contains a sheet flipping mechanism, to the feed path upstream of the print engine so that a second image can be printed on a second side of each sheet in a second print pass;
discharging the finished sheets in a predetermined page sequence;
when a sheet defect is found in a print pass of a sheet, diverting the defective sheet is into an eject path downstream of the print engine;
skipping a print pass for an immediate successor of the defective sheet
recirculating subsequent semi-finished sheets in the duplex loop while the supply of fresh sheets into the feed path is interrupted; and
resuming duplex printing during or after recirculating the subsequent semi-finished sheets.

2. The method according to claim 1, further comprising the steps of:
when the sheet defect is found in the first print pass of a sheet, recirculating the immediate successor of the defective sheet and a number of subsequent semi-finished sheets in the duplex loop; and
resuming printing with a substitute sheet for the defective sheet.

3. The method according to claim 1, further comprising the step of:
when the sheet defect is found in the second print pass of a sheet duplex, resuming printing with the recirculated sheets.

4. The method according to claim 1, further comprising the steps of:
when the sheet defect error occurs, using a number of subsequent sheets as spitting ink collector sheets or for printing recovery patterns on in a recovery process for the print engine; and
then ejecting the number of subsequent sheet via the eject path.

5. The method according to claim 1, further comprising the step of:
steering the semi-finished sheets that are recirculated in the duplex loop to travel two complete rounds through the duplex loop so as to be flipped twice by the sheet flipping mechanism.

6. The method according to claim 1, further comprising the step of:
steering the semi-finished sheets that are recirculated in the duplex loop to travel through the duplex loop only once and to bypass the sheet flipping mechanism.

7. A duplex printer comprising:
a feed path;
a print engine;
a duplex loop;
a sheet flipping mechanism in the duplex loop; and
a controller controlling the print engine and the movements of the sheets in the feed path and the duplex loop,
wherein the controller is configured to perform the method according to claim 1.

8. A duplex printer for carrying out the method according to claim 6, the printer comprising:
a feed path;
a print engine;
a duplex loop;
a sheet flipping mechanism in the duplex loop; and
a controller controlling the print engine and the movements of the sheets in the feed path and the duplex loop, wherein the duplex loop has a bypass controllable to cause the sheets to bypass the sheet flipping mechanism,
wherein the controller is configured to perform the method.

9. A computer program product embodied on a non-transitory computer readable medium that, if executed on a processor, performs the steps of claim 1.
